(19) United States
(12) Patent Application Publication
(10) Pub. No.: US 2016/0302883 A1
(43) Pub. Date: Oct. 20, 2016

(54) ENDODONTIC FILE

(71) Applicant: Kenneth C. SPRECHMAN, Port St. Lucie, FL (US)

(72) Inventor: Kenneth C. SPRECHMAN, Port St. Lucie, FL (US)

(21) Appl. No.: 15/102,220

(22) PCT Filed: Dec. 5, 2014
(86) PCT No.: PCT/US2014/068885

§ 371 Date: Jun. 6, 2016

Related U.S. Application Data
(60) Provisional application No. 61/983,852, filed on Apr. 24, 2014.
(60) Provisional application No. 61/912,129, filed on Dec. 5, 2013.

(51) Int. Cl. A61C 5/02

(52) U.S. Cl. CPC A61C 5/023

(57) ABSTRACT

An endodontic file is disclosed herein. Methods of utilizing the endodontic file during endodontic therapy to treat patients with trismus is also disclosed.

### CROSS REFERENCE TO RELATED APPLICATIONS

This application is a PCT international application claiming the benefit of priority under 35 U.S.C. §119(e) of U.S. Provisional Patent Application Ser. No. 61/912,129, filed Dec. 5, 2013, and U.S. Provisional Patent Application Ser. No. 61/983,852, filed Apr. 24, 2014, the entire disclosures of which are hereby incorporated by reference.

### BACKGROUND

The present disclosure relates to an endodontic file, and in particular to an endodontic file that is short in length.

### SUMMARY

An endodontic file in accordance with the present disclosure includes a stem of shorter length. In illustrative embodiments, a stem of an endodontic file may have a length of 18 mm or less. In another embodiment, a stem of an endodontic file may have a length of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm.

In illustrative embodiments, methods include filing a root canal with an endodontic file having a stem of 18 mm or less. In an embodiment, methods include filing a root canal with an endodontic file having a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an embodiment, the root canal canal can be infected. In an embodiment, methods include providing endodontic therapy by filing a root canal with an endodontic file having a stem of 18 mm or less in a patient with trismus.

### BRIEF DESCRIPTION OF THE DRAWINGS

FIG. 1 shows an endodontic file including a handle 10 and a stem 11, which comprises a shaft 12 and a cutting portion 14.

FIG. 2 shows a curved endodontic file. In this embodiment, a stem includes a substantially straight shaft 12 with a curved cutting portion 16

FIG. 3 shows an endodontic file of the Example. The endodontic file comprises a 14 mm stem 11. Within the stem, the endodontic file includes flutes 3 which are spiraled 9.

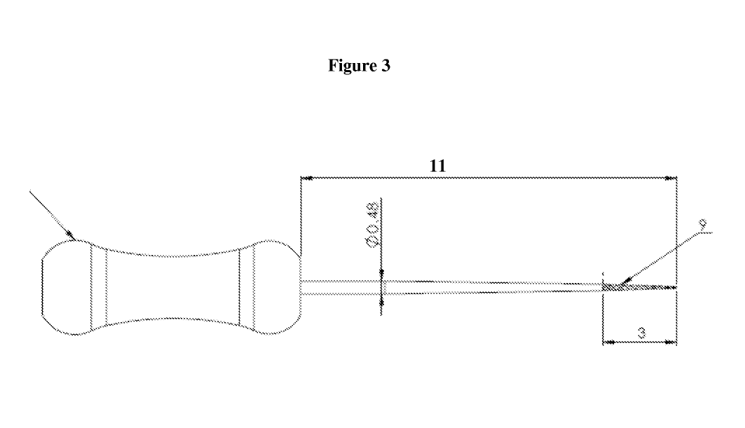

### DETAILED DESCRIPTION

Modern endodontic treatment provides an alternative to the extraction and replacement of an infected tooth. Retaining the original tooth structure is preferable to no tooth or an artificial tooth. Current endodontic files and methods used in endodontic therapy do not address extremely small canals differently than typical canals. Embodiments of an endodontic file described herein address access to narrow canals with a minimal (e.g., 0.06 mm or less) opening, limited access due to tooth positioning (e.g., an angulated tooth), and limited mouth opening. Endodontic files as described herein allows for improved instrumentation of when there is narrow access, limited access, or limited mouth opening.

As used herein, the terms “endodontic therapy” and “root canal therapy” refer to treating an infected or inflamed tooth pulp. Tooth pulp inhabits the “root canal” or “pulp chamber”, which contains blood vessels, nerves, and calcification. Endodontic therapy includes removing tissues of the root canal, typically all the way to the apical foramen. Access to the canal is providing by drilling through tooth structure to create an opening.

“Endodontic files” or “root canal files” are used to remove the tissues of the root canal. Subsequent to the removal of the pulp tissues, the opening in the tooth structure and the hollowed out canal are obturated with inert fillings (e.g., gutta percha, resin based composites, etc.). Generally, an endodontic file provides a tapered shape to more easily obturate the canal with inert fillings and then seal the canal.

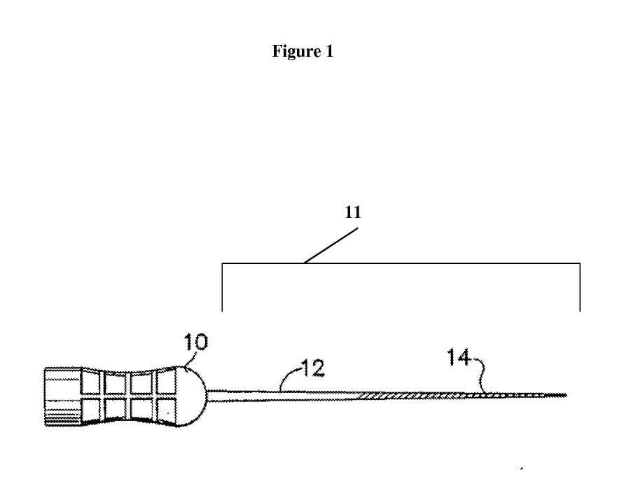

An endodontic or root canal file (FIG. 1) typically includes a handle 10 mounted atop a stem 11. A standard handle 10 is about 10 mm in length. A stem 11 can include a cutting portion 14 with a plurality of cutting flutes formed thereon. A cutting portion 14 is formed on the bottom portion of a stem. Whereas, a shaft 12 is located between the top of the cutting portion 14 and the bottom of handle 10. A shaft can be cylindrical and smooth. A shaft does not include cutting flutes. Flutes on a cutting portion 14 attach to tissue within a tooth and pull the tissue therefrom. In an embodiment, an endodontic file lacks a shaft.

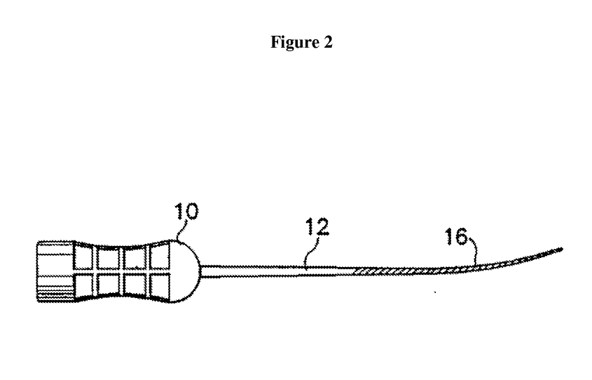

In an embodiment, an endodontic file can include a stem that is curved (FIG. 2). In an embodiment, a stem includes a substantially straight shaft 12 with a curved cutting portion 16.

An endodontic file as described herein can include any type of cutting portion 14. Embodiments of the endodontic file are not limited to specific types, patterns, etc. of the cutting portion. 14

A file can be manually inserted into a tooth hole leading to the interior of the tooth and is rotated and moved in and out of the hollow interior by means of the dentist twisting, pulling, and pushing the handle 10 relative to the tooth. An endodontic file as described herein can also attach to a rotary instrument. A rotary instrument can mechanically rotate an attached endodontic file.

Typical file lengths are 21 mm, 25 mm, and 31 mm. In an embodiment, an endodontic file comprises a stem of a short length. A stem having a short length allows increase accessibility in minimal openings, particularly with a second mesiobuccal (MB₂) canal. Further, endodontic files comprising a stem of a short length provides greater visibility to the dentist, particularly when using a microscope during endodontic therapy. Endodontic files having a shorter length, and thereby a shorter cutting surface, can have an increased stiffness to the file. In an embodiment, an endodontic file comprises a stem, wherein the stem is 18 mm or less, 17 mm or less, 16 mm or less, 15 mm or less, 14 mm or less, 13 mm or less, 12 mm or less, 11 mm or less, 10 mm or less, 9 mm or less, or 8 mm or less. In an embodiment, a stem is 18 mm, 17 mm, 16 mm, 15 mm, 14 mm, 11 mm, 12 mm or less. In an embodiment, a stem is 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm.

In an embodiment, an endodontic file can have minimal taper. In an embodiment, an endodontic file can have a taper of 0.04, 0.03, 0.02, or 0.01 mm. For every step back from the apex of 1 mm, the file diameter increase 0.02 mm in a 0.02 taper. In an embodiment, the endodontic file has no taper.

In an embodiment, an endodontic file includes a cutting portion 14 located on the distal end. In an embodiment, a cutting portion can be 5 mm or less, 4 mm or less, 3 mm or less, 2 mm or less, or 1 mm or less. In an embodiment, the cutting portion is about 5 mm, about 4 mm, about 3 mm, about 2 mm, or about 1 mm. The cutting portion can include 1, 2, 3, 4, or 5 flutes. In an embodiment, the cutting portion is the flue length of the endodontic file. In an embodiment, an endodontic file may have 12, 11, 10, 9, 8, 7, 6, 5, 4, or 3 flute spirals

In an embodiment, an endodontic file as described herein can include a standard handle or a handle having a decreased diameter (as compared to a standard diameter). A smaller diameter handle increases visibility, particularly in molars and particularly when endodontic therapy is performed with a microscope.

In an embodiment, a stem of an endodontic file is stainless steel or a nickel titanium alloy (NiTi). In an embodiment, a stem of an endodontic file is stainless steel.

In an embodiment, an endodontic file comprises a stem with a non-cutting end. In an embodiment, a portion of a stem above the non-cutting distal end comprises a cutting surface. In an embodiment, there is another non-cutting portion above (closer to the handle) the cutting surface that is also part of the stem, where the stem comprises a non-cutting distal end.

In patients with particular disease states, the ability to perform endodontic therapy can be limited due to trismus. The term “trismus” refers to any restriction to mouth opening, including, but not limited to, restrictions caused by trauma, surgery or radiation. A restricted mouth opening may be caused by muscle damage, joint damage (e.g., temporomandibular joint TMJ)), connective tissue growth (i.e., scarring), conditions external to the joint, or combinations thereof. Conditions external to the joint include, but are not limited to, systemic diseases (e.g., scleroderma, central nervous disorders including multiple sclerosis, Raynaud's disease, etc.), muscle trauma, myositis, infection, tumor, TMJ pseudoankylosis, burn injuries, etc. Joint damage can include, but is not limited to, bony ankylosis, fibrous ankylosis, arthritis, infection, trauma etc. For example, patients with scleroderma may not provide a large mouth opening due to general tightening of the facial skin.

An embodiment thereby includes a method of endodontic therapy comprising filing a root canal in a patient with trismus with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less. Another embodiment includes a method of endodontic therapy comprising filing a root canal in a patient with trismus with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an embodiment, a method of endodontic therapy comprises filing a root canal in a patient with trismus with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less, wherein the canal is in a premolar or molar tooth. Another embodiment includes a method of endodontic therapy comprising filing a root canal in a patient with trismus with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm, wherein the canal is in a premolar or molar tooth.

An embodiment thereby includes a method of endodontic therapy comprising filing a root canal with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less, wherein there is limited access. Another embodiment includes a method of endodontic therapy comprising filing a root canal with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm, wherein there is limited access. The term “access” refers to the space required to view a tooth and manipulate dental instruments to remove decay and prepare the tooth for restoration. The term “access” also refers to the opening in the crown of a tooth necessary to allow admittance to the pulp space to clean, shape, and seal the root canal. In an embodiment, a root canal with limited access is opened up by filing with an endodontic file as described herein and then is followed by filing with an endodontic file of standard length.

The term “narrow canal” refers to a root canal where a tip of an endodontic file does not enter or barely enters the canal. Such a root canal is considered narrow, calcified, or both. In an embodiment, a narrow canal is a root canal where an endodontic file of 0.06, 0.08, or 0.10 taper does not enter or barely enters the canal. In an embodiment, a method of endodontic therapy comprises filing a narrow root canal, a calcified root canal, or a narrow and calcified root canal with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less. Another embodiment includes a method of endodontic therapy comprising filing a narrow root canal, a calcified root canal, or a narrow and calcified root canal with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an illustrative embodiment, a method of endodontic therapy comprises filing a narrow root canal, wherein the narrow root canal does not fit an endodontic file of 0.06, 0.08, or 0.10 taper. In an embodiment, a root canal with a narrow canal is opened up by filing with an endodontic file as described herein and then is followed by filing with an endodontic file of standard length.

Endodontic files as described herein allows for improved instrumentation of when there is narrow access, limited access, or limited mouth opening. The improved instrumentation particularly helps when the tooth being treated for endodontic therapy is a molar (tooth nos. 1-3, 14-19, and 30-32) and/or a premolar (tooth nos. 4-5, 12-13, 20-21, and 28-29).

### Example

Three NiTi endodontic files comprising a stem having a shorter length were produced. A size 0.08, a size 0.10, and a size 0.15 endodontic files were produced with a stem of 14 mm and a taper of 0.03. The cutting surface of the files had 4 flutes (9 spirals) and a length of 3 mm. Additionally, the files had a tip angle of 75°. The files had no shafting.

| | Diameter measurement from the tip of the file (mm) | | | | | |
|---|---|---|---|---|---|---|
| Size | 0.5 | 1 | 3 | 8 | 10 | 12 |
| 0.08 | 0.10 | 0.11 | 0.17 | 0.32 | 0.38 | 0.44 |
| 0.10 | 0.12 | 0.13 | 0.19 | 0.34 | 0.40 | 0.46 |
| 0.15 | 0.17 | 0.18 | 0.24 | 0.39 | 0.45 | N/A |

One set of endodontic files were produced with increased flute depth as compared to a standard flute depth. This provided increased flexibility compared to an endodontic file of the same length with a standard flute depth. A second set of endodontic files were produced with a slightly decreased flute depth as compared to a standard flute depth. The endodontic files with the decreased flute depth had an increased stiffness.

1. An endodontic file comprising a handle and having attached thereto a stem, wherein the stem is from 12 mm to 18 mm in length.

2. The endodontic file of claim 1, wherein the stem is 14 mm, 13 mm, or 12 mm.

3. The endodontic file of claim 1, comprising a cutting portion that is 5 mm in length or less.

4. The endodontic file of claim 3, wherein the cutting portion is about 3 mm in length.

5. The endodontic file of claim 3, wherein the cutting portion comprises a plurality of flutes.

6. The endodontic file of claim 5, wherein the cutting portion comprises 3 flutes.

7. The endodontic file of claim 5, wherein the flutes comprise 7, 8, 9, 10, 11, or 12 spirals.

8. The endodontic file of claim 7, wherein the flutes comprise 8 spirals.

9. The endodontic file of claim 7, wherein the flutes comprise 9 spirals.

10. The endodontic file of claim 7, wherein the flutes comprise 10 spirals.

11. A method of endodontic therapy in a patient comprising filing a root canal with an endodontic file of claim 1, wherein the patient has trismus.

12. The method of claim 11, wherein the root canal is a molar or premolar root canal.
